(19) United States
(12) Patent Application Publication
(10) Pub. No.: US 2006/0208410 A1
(43) Pub. Date: Sep. 21, 2006

(54) Multi-layered cutting board assembly

(75) Inventor: Robert Grant McRorie III, Huntersville, NC (US)

Correspondence Address: LEMPIA IP GROUP, LLC, 223 WEST JACKSON BLVD., SUITE 1100, BROOKS BLDG., CHICAGO, IL, 60606, US

(73) Assignee: RUBBERMAID INCORPORATED, Fairlawn, OH (US)

(21) Appl. No.: 11/085,432

(22) Filed: Mar. 21, 2005

(51) Int. Cl. B23Q 3/00

(52) U.S. Cl. 269/289 R

(57) ABSTRACT

A cutting board assembly has a plurality of material layers stacked and removably adhered to one another. Each of the plurality of material layers has a length, width, generally planar opposed surfaces, and a thickness between the opposed surfaces. An overall thickness of the cutting board assembly is defined by the combined thicknesses of the plurality of material layers. One of the opposed surfaces on each material layer defines a potential cutting surface. The plurality of material layers are sequentially removable from the cutting board assembly to expose a fresh potential cutting surface. Either one or both of the planar opposed surfaces can provide a potential cutting surface.

### BACKGROUND OF THE INVENTION

1. Field of the Disclosure

The present disclosure is generally related to cutting boards, and more particularly to a cutting board assembly having multiple-layers that can be individually removed and discarded upon removal from the cutting board assembly and exhaustion of a cutting surface.

2. Description of Related Art

Cutting boards are well known and are typically fabricated from either wood or plastic. Typical cutting boards are formed of a solid piece of material having two sides, at least one of which is a potential cutting surface. Often, both sides of a cutting board are usable as cutting surfaces.

Both wood and plastic cutting board surfaces wear or become exhausted over time, as deep cuts eventually permeate the cutting surface. These deep cuts are difficult to clean and can trap food particles. Trapped food can create bacterial contamination and, thus, health issues for the board user and the people that ultimately consume the food product cut on such boards. Home users and commercial kitchens that utilize wood cutting boards often will sand down the surfaces of the boards to reduce or eliminate deeper cuts. However, the cutting surface will thus eventually become uneven and/or the board will become too thin and must be discarded. Plastic cutting boards may similarly be sanded. However, it is more typical for a user to simply discard a plastic cutting board when its cutting surface or surfaces become too damaged or over-used.

Cutting boards, particularly those made from plastic, have been provided in different colors for an end user so that the user can identify which boards, such as in a commercial cooking environment, are used for when particular type of food. This way, a board typically used for cutting chicken will always be used for cutting chicken and not for other food products. This may reduce or eliminate cross-contamination between food types and used cutting boards. However, the solution does not affect the overall life span or improve food contamination or wear damage to cutting boards. Home users typically cut a variety of foods on the same cutting surface. Cross-contamination will eventually result, which can among other things cause harm to those having severe food allergies.

Traditional plastic cutting boards are about one-half inch thick and are usually placed directly on a support surface for cutting. In commercial settings, the support surface is often a stainless steel counter top or other surface. During use, such a cutting board may have a tendency to slip and slide over the surface. This creates a risk of injury to the user in that they could inadvertently cut themselves. One solution to this problem has been to provide a separate product that “houses” the cutting board. The housing acts as an intermediate layer between the cutting board and the support or counter top surface and is known to provide a non-slip function.

Also, a typical plastic cutting board is often washed using high temperature equipment such as dish washers. Home dish washers, and even more so, commercial dish washers, can operate at extremely high temperatures. Wash cycles have a tendency to warp such plastic cutting boards.

### BRIEF DESCRIPTION OF THE DRAWINGS

Objects, features, and advantages of the present invention will become apparent upon reading the following description in conjunction with the drawing figures, in which:

FIG. 1 shows a perspective view of a multi-layered cutting board assembly constructed in accordance with the teachings of the present invention.

FIG. 2 shows a plan view of the cutting board assembly shown in FIG. 1.

FIG. 3 shows an enlarged edge view of a portion of the cutting board assembly shown in FIG. 1.

FIG. 4 shows a fragmentary perspective view of another example of a multi-layered cutting board assembly constructed in accordance with the teachings of the present invention.

FIG. 5 shows a cross-section taken along line V-V of FIG. 4 and showing the assembled structure.

FIG. 6 shows a perspective view of another example of a multi-layered cutting board assembly constructed in accordance with the teachings of the present invention.

FIG. 7 shows a cross-section of one example of a cutting board layer constructed in accordance with the teachings of the present invention. And suitable for the assembly of FIG. 6;

FIG. 8 shows a cross-section of another example of a cutting board layer.

FIG. 9 shows a cross-section of another example of a cutting board layer.

### DETAILED DESCRIPTION OF THE DISCLOSURE

The present invention is directed to a multi-layered cutting board assembly wherein individual layers can be removed from the assembly and discarded as their cutting surfaces become damaged or exhausted. The disclosed cutting board assemblies include a plurality of material layers stacked and removably adhered to one another. Each of the plurality of layers generally has opposed planar surfaces and a thickness between the opposed surfaces. An overall thickness of the cutting board assembly is defined by the combined thicknesses of the plurality of material layers. At least one of the opposed surfaces on each of the material layers defines a potential cutting surface. Each of the plurality of material layers is sequentially removable from the cutting board assembly to expose fresh potential cutting surfaces. Depending on the particular embodiment of the cutting board assembly, a fresh potential cutting board surface may be on a surface of a removed layer, on an exposed surface of the remaining cutting board assembly, or both.

Referring now to the drawings, FIGS. 1-3 illustrate one example of a multi-layered cutting board assembly 10 constructed in accordance with the teachings of the present invention. The cutting board assembly 10 generally has a plurality of material layers or cutting board layers 12 that are stacked relative to one another. In each of the disclosed examples herein, each of the cutting board layers 12 is removable from the cutting board assembly. In general, each of the plurality of cutting board layers 12 has a length L defined along its respective side edges 14. Each of the cutting board layers 12 also has a width W defined along its top and bottom edges 16. Each of the plurality of cutting board layers 12 also includes generally planar opposed surfaces including a top surface 18 and a bottom surface 20 according to orientation shown in FIG. 1. These orientations are merely provided herein for ease of explanation and description. Depending upon the particular example of a cutting board assembly, the actual assembly may be invertable, and thus not have a specific top or bottom as these terms may conventionally be used.

Each of the cutting board layers 12 also has a thickness defined between the top surface 18 and the bottom surface 20. An overall thickness of the cutting board assembly is defined by the combination of the individual cutting board layer thicknesses. The thickness of each of the cutting board layers 12, and the overall thickness of the cutting board assembly 10, can vary considerably and yet fall within the spirit and scope of the present invention. In one example, the combined thickness of the cutting board assembly can be about the same as a conventional plastic cutting board, or about 0.50 inches. However, the invention is not intended to be limited to any particular materials or material thicknesses. In one example of the invention, a material thickness for an individual cutting board layer 12 can be on the order of about 0.06 inches. Eight or ten of such layers could be used to create an assembly having a thickness similar to that of a conventional plastic cutting board.

Additionally, the particular, materials used for the cutting board surfaces can vary considerably and yet fall within the spirit and scope of the present invention. Materials and variations in construction of a given layer are described below in greater detail. The various examples of individual cutting board layer constructions and materials used can vary and can also be employed in any of the disclosed examples as desired.

Returning to the example shown in FIGS. 1-3, at least one, if not both, of the opposed surfaces 18 and 20 on each of the material layers is intended to define a potential cutting surface. A potential cutting surface as used herein is a surface that is constructed and configured in such a manner so as to provide a useful and durable surface on which food items can be cut utilizing sharp implements. The cutting surfaces are not intended to last forever, but are intended to be used and suitable for cutting food items thereon and to last at least long enough to achieve an acceptable useful life. A given useful life can also vary according to a desired application of the disclosed cutting board assemblies. Once the available cutting surface or surfaces on a given layer 12 is or are exhausted, the layer 12 can be discarded.

The disclosed cutting board assembly 10 shown in FIGS. 1-3 is arranged such that each of the plurality of cutting board layers 12 can be sequentially removed from the assembly in order to expose a fresh potential cutting surface. A potential cutting board surface can be on either the top surface 18, the bottom surface 20, or both surfaces of each layer, depending upon the particular construction and application for the cutting board assembly 10.

A number of different examples of cutting board assemblies are disclosed herein that are configured to provide different utilizations of the various individual layers 12 and the assembly 10. In one general example, the cutting board assembly 10 can always include at least one exposed cutting surface that can be utilized for preparing food items. Thus, the cutting board assembly 10 itself can be used as the cutting board. In another example, an individual cutting board layer 12 can provide an exposed and fresh potential cutting surface on its previously unexposed bottom surface. Thus, the removed cutting board layer 12 can be used as a cutting board separate from the cutting board assembly 10. In a further example, a top side 18 of an exposed layer 12 of the assembly 10 can be used as a cutting surface. When that surface is exhausted, the specific layer 12 can be removed from the assembly 10 exposing both a fresh potential cutting surface 20 on the underside of the removed layer 12 and an additional fresh potential cutting surface 18 exposed on the remainder of the cutting board assembly 10. Various examples of cutting board assemblies 10 are disclosed and described herein in order to achieve these various arrangements. Other cutting board configurations and constructions are clearly permissible that will fall within the scope of the claims, and yet will have not been described herein.

Returning to FIGS. 1-3, in one example the cutting board assembly 10 has a bound region 22 along a portion of the top edges 16 of the cutting board assembly. In the bound region 22 in this example, the adjacent and facing surfaces of each of the individual cutting board layers 12 of the cutting board assembly 10 are adhered to one another so that they remain attached within the bound region. The layer surfaces within the bound region 22 can be adhered to one another in any suitable manner. They can be glued or otherwise fastened to one another, or a separate binder can be added to secure the bound region. In the example of FIGS. 1-3, the bound region could be adhered using a passive adhesive in an arrangement similar to a stack of POST-IT® Notes, whereby an entire layer could be removed from the stack without leaving behind any portion in the bound region. Alternatively, the bound region could be glued together using an adhesive and an over-layer, similar to a standard note pad of paper.

A frangible connection 24 is provided on each of the individual cutting board layers 12 connecting the layers in the bound region 22 to the remainder of each of the layers. In this example as shown in FIG. 1, an individual cutting board layer 12 can be lifted from the remainder of the cutting board assembly 10 and removed along the frangible connection 24 from the bound region 22. Also in this example, the bound region 22 can include features or structures that can be utilized to mount or hang the cutting board assembly 10 to a wall or other mounting surface. In this example, a pair of holes or openings 26 extends completely and perpendicularly through the bound region 22 and through the overall combined thickness of the cutting board assembly 10. The holes 26 can be utilized in this example to suspend the cutting board assembly 10 from a pair of hooks. Clearly more of the openings 26, or a single centered opening can be provided and yet fall within the spirit and scope of the present invention. Also, different structures and arrangements can also be provided for mounting or other wise securing the cutting board assembly 10 to a desired surface for storing the assembly and for presenting the assembly for use.

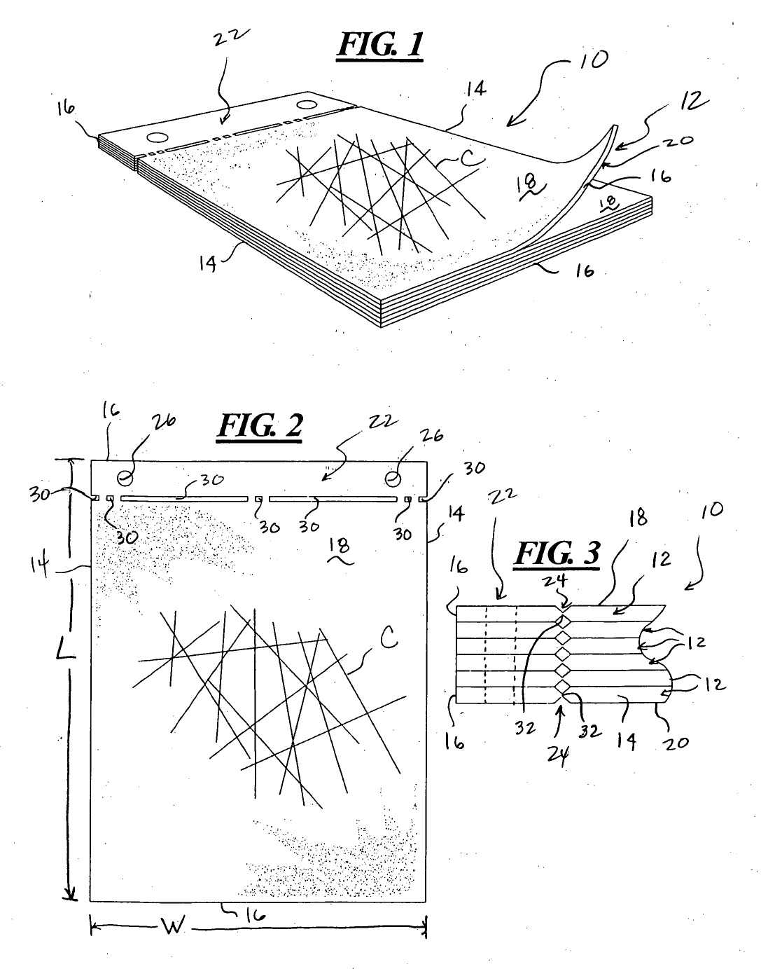

The structure of the frangible connections 24 can also vary considerably and yet fall within the spirit and scope of the present invention. In one example, the frangible connection 24 on each of the layers can simply be a thin-walled cross-section extending across the entire width W of each layer 12 of the cutting board assembly 10. FIG. 3 illustrates one example of such a thin walled cross-section. In another example depicted in FIG. 2, elongate slots or openings are molded, cut, or punched through each layer over a vast majority of the width W of the cutting board assembly. A plurality of adjoining strips 32 are interspersed along the slots. As depicted in FIG. 3, these adjoining strips 32 can be configured and constructed identically to the thin-walled cross-section or frangible connection that extends across an entire width W of the assembly.

Whatever the construction of the frangible connection 24, the intent is to make the useful majority of a cutting board layer 12 relatively easily removable from the bound region 22 and the remainder of the cutting board assembly 10. Where no layer 12 is to removed, however, the frangible connections 24 are intended to securely hold each of the material layers 12 separately to the bound region 22. Other examples of frangible connection structures may include a standard perforated region, similar to a removable section of a piece of paper in a standard note pad, or a coined living hinge formed in each layer 12 after the layers are fabricated.

In the example of FIGS. 1-3, each of the top side 18 and bottom side 20 of the material or cutting board layers 12 can define a potential cutting surface. In another example, the bottom side 20 of each of the material layers (or the top side 18 as desired) can include a thin layer of adhesive that removably retains the individual layers 12 together. In this example, a user would be required to lift a layer 12 to be removed, as depicted in FIG. 1 and peel that layer from the remainder of the cutting board assembly 10. Either of these examples is reasonably within the scope of the example shown in FIGS. 1-3. Also, though no adhesive may be present, if desired, perhaps only, one of the top or bottom surfaces 18 or 20 of each material layer 12 may be a potential cutting surface.

The exposed cutting board layer 12 in FIG. 1 illustrates a plurality of cuts C indicating that the cutting surface 18 has been utilized and in this example has become exhausted. An intent of the present invention is to permit a user to, if desired, remove an exhausted layer 12 and simply discard that layer or turn it over and use the previously unexposed bottom side 20 as an additional cutting surface. Removal of one layer may also expose a fresh potential cutting surface 18 on the next available layer 12 of the assembly 10.

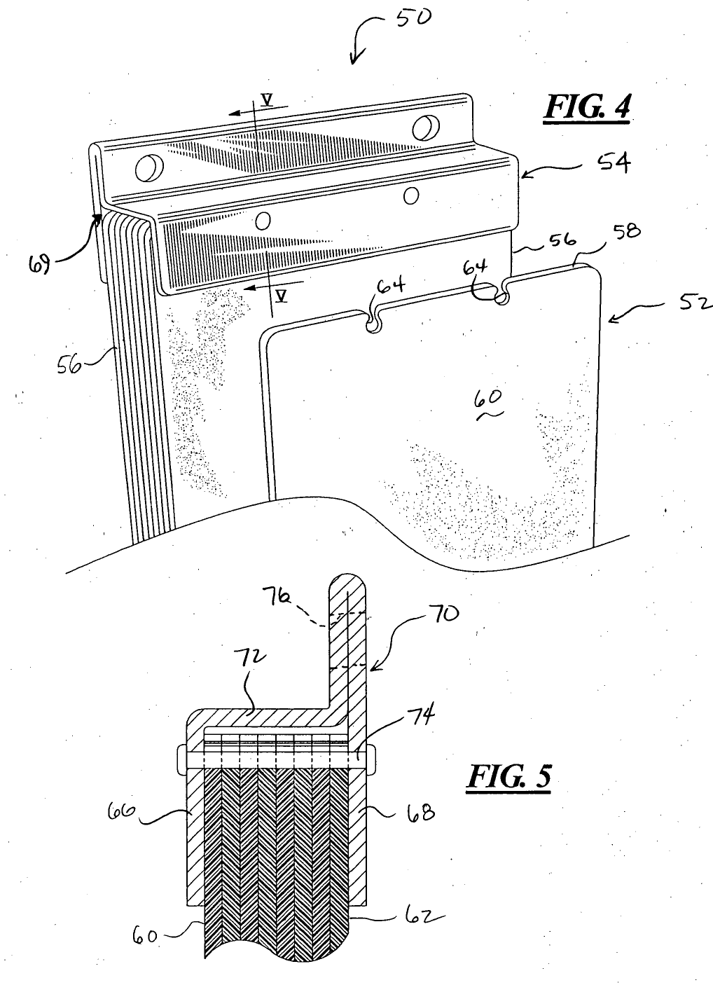

Referring now to FIGS. 4 and 5, another example of a cutting board assembly 50 is disclosed and is constructed in accordance with the teachings of the present invention. In this example, the assembly 50 includes a plurality of cutting board layers 52 removably connected to one another by a separate or discrete retainer 54. In this example, each of the layers 52 again has a length L defined along opposed side edges 56 and a width W defined along a top edge 58 and a bottom edge (not shown) of the cutting board layers. Each of the cutting board layers 52 also includes an exposed top or front surface 60 and an opposite bottom or rear surface 62. The individual cutting board layers 52 in this example can be similarly constructed from materials and having material arrangements described both below and above with reference to the various disclosed layers of the cutting board assemblies.

In this example, each of the cutting board layers 52 has a pair of narrow entry notches or slots 64 provided extending into the top edge 58. These slots 64 are provided to removably attach or secure each of the layers 52 to the separate retainer 54.

As depicted in FIGS. 4 and 5, the retainer in this example generally has a front panel 66 and a rearwardly spaced apart back panel 68. A receiving gap 69 is defined between the spaced apart front and back panels 66 and 68, respectively. In this example, the back panel 68 extends upward a distance beyond the receiving gap 69 and is sharply curved downward against itself forming a double layer mounting flange 70 along the top back side of the retainer 54. The front panel 66 continues upward and then folds 90° to form a top panel 72 extending between the front panel and the mounting flange 70 above the gap 69. The gap 69 has a depth sized to receive therein the top edges of a desired maximum number of cutting board layers 52 and has a width similar to the width of the layers in this example.

A pair of pins 74 are provided extending transversely through the gap between the front and back panels 66 and 68, respectively. The pins are spaced laterally apart across the width of the retainer 54 and match the distance between the slots 64 in the top edges 58 of the individual layers 52. The diameter of the pins 74 is sized to be forceably received through the narrow entry of the slots 64 until they seat in the wider base portion of the slots to retain the cutting board layers 52 suspended or secured to the pins. As with the frangible connections 24 of the first embodiment, the configuration and construction of the pin diameter and the narrow entry slot 64 configuration are configured so that the individual cutting board layers 52 remain secured to the retainer 54, but can be readily removed as desired by a user.

Also as with the first example, in this example, a pair of mounting openings 76 are provided extending through the mounting flange 70. These openings 76 can be provided for suspending or other wise securing the cutting board assembly 50 to a desired storage surface or a wall. Again, these openings 76 are just one example of a structure that can be optionally provided to mount or otherwise store the assembly. A single centered opening or three or more openings can also be utilized. The pins can also vary in configuration and construction, and can be in the form of rivets, screws, bolts, or the like.

In this example, the retainer 54 is shown in cross-section as having a metal construction. However, as will be evident to those having ordinary skill in the art, the retainer 54 can be formed from any suitable material, such as suitable plastics, and can also take on a wide variety of configurations and constructions and yet fall within the spirit and scope of the present invention. The disclosed retainer 54 is just one of many possible examples of a retainer that can be utilized to effectively create a bound region to secure a plurality of the cutting board layers 52 into an assembly 50. The top ends of the layers in the assembly can simply be riveted or stapled together if desired. Also, the particular configuration and construction of the individual layers 52 can vary according to the overall disclosure provided herein.

In another example, the retainer 54 can be affixed to a wall or counter surface, or even be provided as an integral part of a kitchen appliance or storage unit. Refillable cutting board assemblies or cartridges could be provided to refill an empty retainer. In a further example, a stack of layers 12 or 52 could be provided with a simple hang-tag attached, such as by stapling, to one or more of the layers. The hang-tag could be separately attached as the mounting flange to a retainer, similar to the example of FIGS. 4 and 5, or could be attached to the assembly depicted in FIGS. 1-3.

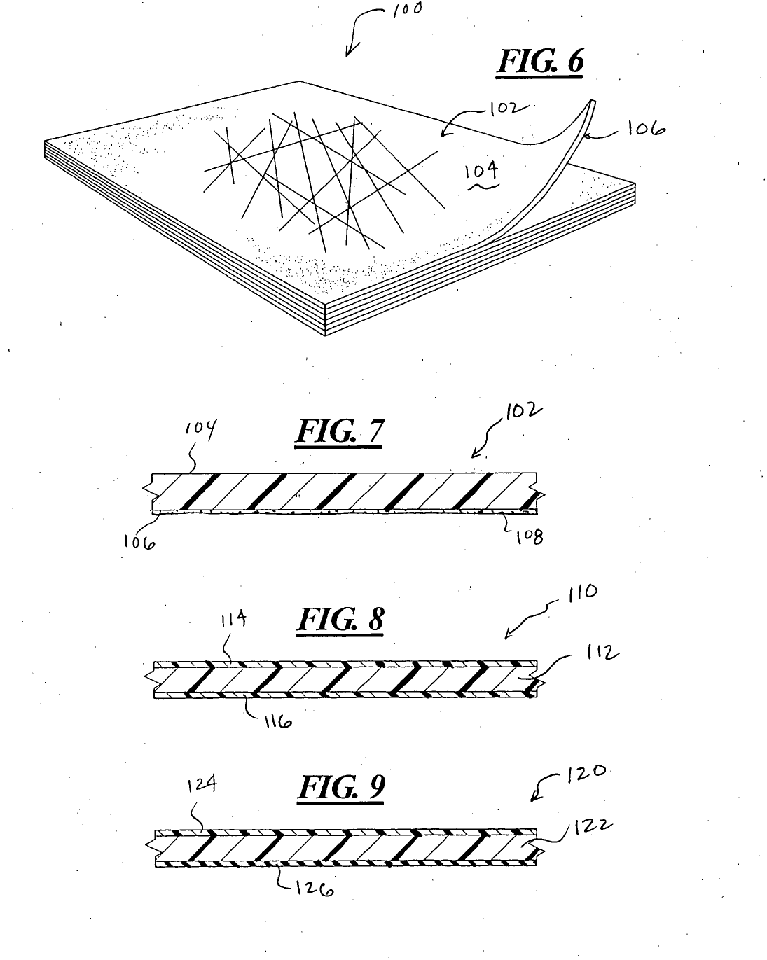

Referring now to FIGS. 6 and 7, another example of a cutting board assembly 100 is described and is constructed in accordance with the teachings of the present invention. The cutting board assembly 100 includes a plurality of cutting board layers 102 wherein the entirety of the length L and width W of each layer provides a cutting board surface. There is no retainer or bound region in this example. Instead, each of the layers is provided having a top potential cutting surface 104 and a bottom surface 106 covered by or at least partly carrying a passive adhesive 108 as shown in FIG. 7. In this example, the passive adhesive can be virtually any suitable adhesive. The adhesive should, for best results, be retained on at least a part of the bottom surface 106 of the layer 102 and not adhere to, or otherwise affect, the next exposed cutting surface 104 of a subsequent cutting board layer 102 of the assembly 100. The adhesive can be provided over the entire bottom surface, or along only the top edge, similar to the previously mentioned POST-IT® Note configuration.

FIG. 8 illustrates an alternate example of a cutting board layer 110 constructed in accordance with the teachings of the present invention. In this example, the cutting board layer 110 includes a core material 112 provided from a relatively sturdy but somewhat flexible material. The disclosed layer 110 includes a top potential cutting surface layer 114 and an identical bottom potential cutting surface layer 116 permanently affixed to the core layer 112. In this example, the thin top and bottom layers 116 create a suitable and highly durable potential cutting surface on both surfaces of the core layer 112 and, thus, the cutting board layer 110. In one example as shown, each of the layers 112, 114, 116 is formed of a plastic material, such as polypropylene, high density polyethylene, or NYLON, as depicted in FIG. 8.

In one example, the core layer can assist in preventing cut-through of the entire layer, if the cutting surface layer is perforated by a knife. In another example, the core layer 112 can be a substantially flexible material and the thinner outer layers 114 and 116 can provide stiffness, as they are likely to be harder, more durable surface layers. The materials chosen to construct a cutting board layer 110, 112, and/or 114 can vary considerably, as with other embodiments disclosed herein, and yet fall within the spirit and scope of the present invention.

FIG. 9 illustrates yet another example of a cutting board layer 120 constructed in accordance with the teachings of the present invention. In this example, a higher end construction is disclosed as having a core layer 122 that can be similar to the described core layer 112 in the previous example. A top potential cutting surface layer 124 is permanently affixed or otherwise adhered to a top surface of the core layer 122 to define a durable cutting surface. In this example, a bottom non-slip or high friction surface layer 126 is affixed or adhered to the bottom surface of the core layer 122. In this example, the cutting board layer 120 can be removed from a cutting board assembly (not shown) similar to those previously described and can then be used as an individual discrete cutting board separate from the overall assembly. The non-slip or high friction surface 126 can be rested on any surface to securely hold the cutting board layer 120 in place during use and to prevent or inhibit slippage during use. The high friction or non-slip surface layer 126 can be provided from a suitable rubber material, but is not intended to be so limited.

FIGS. 7-9 disclose three possible examples of alternative cutting board layers. The previous examples in FIGS. 3 and 5 disclose single, unitary cutting board layers formed of a single material. The material can be chosen to be durable and, if desired, to provide a cutting surface on either or both sides of the layers disclosed therein.

Again, any of the disclosed examples, other than perhaps the example of FIGS. 6 and 7, can be provided so as to permit using an exposed top or bottom surface of the cutting board assembly as a potential cutting surface, or just one of the exposed top or bottom surfaces as the cutting board assembly. Each of the disclosed examples can also be utilized so that a removed cutting board layer can be used as a cutting board or potential cutting surface separate from the assembly from which it came. Only the top surface of the cutting board layers of FIG. 7 is suitable for cutting.

Methods of fabricating the disclosed cutting board assemblies and cutting board layers can vary considerably and yet fall within the spirit and scope of the present invention. The individual layers can be extruded in unitary single layers and cut to size or can be co-extruded where each layer is a combination of two or more sub-layers as shown in FIGS. 7-9. The single material layers can also be injection molded. The multi-material layers can be dual-shot or insert injection molded to create the sub-layer construction. For example, a plastic layer can be fabricated and then inserted into a mold whereby a non-slip rubber layer is then molded to the inserted plastic layer.

Health inspections for commercial eating and food preparation establishments are common, rigorous, and becoming ever more important. Health inspectors may give high marks for utilization of the cutting board assemblies disclosed herein, or even recommend their usage.

Although certain cutting boards and methods have been disclosed and described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A cutting board assembly comprising:
a plurality of material layers stacked and removably adhered to one another, each of the plurality of material layers having a length, a width, generally planar opposed surfaces, and a thickness between the opposed surfaces, an overall thickness of the cutting board assembly defined by the combined thicknesses of the plurality of material layers, one of the opposed surfaces on each material layer defining a potential cutting surface, and the plurality of material layers being sequentially removable from the cutting board assembly to expose a fresh potential cutting surface.

2. A cutting board assembly according to claim 1, wherein the cutting board assembly has an exposed potential cutting surface on an outermost layer on one side of the cutting board assembly.

3. A cutting board assembly according to claim 1, wherein upon removal from the cutting board assembly a removed layer has a freshly exposed potential cutting surface on a previously unexposed side of the removed layer.

4. A cutting board assembly according to claim 1, wherein upon-removal of an outermost material layer from the cutting board assembly, a fresh potential cutting surface is exposed on a previously underlying material layer of the cutting board assembly.

5. A cutting board assembly according to claim 1, wherein the cutting board assembly has an exposed potential cutting surface on an outermost layer on each side of the cutting board assembly.

6. A cutting board assembly according to claim 1, wherein each of the opposed surfaces on each of the plurality of material layers defines a potential cutting surface.

7. A cutting board assembly according to claim 6, wherein an outermost layer on each side of the cutting board assembly can be removed to expose a fresh potential cutting surface on either side of the cutting board assembly.

8. A cutting board assembly according to claim 1, wherein the plurality of material layers are adhered to one another along one common edge.

9. A cutting board assembly according to claim 8, further comprising a retainer to which the common edge of each material layer is removably attached.

10. A cutting board assembly according to claim 9, further comprising:
one or more tapered slot formed in the common edge of each material layer; and
one or more pins traversing a space within the retainer, the one or more pins arranged perpendicular to a plane of the plurality of material layers, and the one ore more tapered slots of each material layer configured to be resiliently retained on the one or more pins.

11. A cutting board assembly according to claim 8, wherein the adhered material layers along the one common edge create a bound region, and wherein each of the plurality of material layers is removably connected along a frangible joint to the bound region near that layer's respective common edge.

12. A cutting board assembly according to claim 1, wherein one or more holes are provided through the combined thickness of a portion of the cutting board assembly near a common edge of the plurality of material layers to hang the cutting board assembly.

13. A cutting board assembly according to claim 1, wherein each of the plurality of material layers is a laminate of two sub-layers of material including a first base material and a second material adhered to one side of the base material and forming the potential cutting surface.

14. A cutting board assembly according to claim 13, wherein each of the plurality of material layers has a third sub-layer of material adhered to the first base material and sandwiching the base material between the third sub-layer and the second material.

15. A cutting board assembly according to claim 14, wherein the third sub-layer also forms a potential cutting surface.

16. A cutting board assembly according to claim 14, wherein the third sub-layer is a friction enhancing non-skid material.

17. A cutting board assembly according to claim 1, wherein each of the plurality of material layers is adhered by an adhesive to adjacent layers over a majority of a surface area of the opposed surfaces, and wherein an outermost layer is peeled from the cutting board assembly to remove the outermost layer.

18. A method of refreshing a cutting surface on a cutting board, the method of comprising the steps of:
providing a cutting board assembly having multiple layers of generally thin material, the multiple layers arranged in a stack and adhered to one another, each of the multiple layers having a length, a width, generally planar opposed surfaces, one of the opposed surfaces on each of the multiple layers defining a potential cutting surface; and
removing an outermost layer of the multiple layers from the cutting board assembly to expose a fresh potential cutting surface.

19. A method according to claim 18, further comprising the step of:
repeating the step of removing each time a potential cutting surface is exhausted in order to expose a fresh potential cutting surface, until all of the potential cutting surfaces of the multiple layers have been exhausted.

20. A method according to claim 18, wherein the step of removing further comprises exposing a fresh cutting surface on a newly exposed layer of the cutting board assembly or on a previously unexposed surface of the removed outermost layer.
